(19) United States
(12) Patent Application Publication
(10) Pub. No.: US 2007/0296721 A1
(43) Pub. Date: Dec. 27, 2007

(54) Apparatus and Method for Producting Multi-View Contents

(75) Inventors: Eun-Young Chang, Jeollabuk-do (KR); Gi-Mun Um, Daejeon (KR); Daehee Kim, Daejeon (KR); Chung-Hyun Ahn, Daejeon (KR); Soo-In Lee, Daejeon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejon (KR)

(21) Appl. No.: 11/718,796

(22) PCT Filed: Jul. 26, 2005
(86) PCT No.: PCT/KR05/02408

§ 371 Date: May 7, 2007

(30) Foreign Application Priority Data
Nov. 8, 2004 (KR) 10-2004-0090526

(51) Int. Cl. G06T 15/10

(52) U.S. Cl. 345/427

(57) ABSTRACT

Provided are a contents generating apparatus that can support functions of moving object substitution, depth-based object insertion, background image substitution, and view offering upon a user request and provide realistic image by applying lighting information applied to a real image to computer graphics object when a real image is composited with computer graphics object, and a contents generating method thereof. The apparatus includes: a preprocessing block, a camera calibration block, a scene model generating block, an object extracting/tracing block, a real image/computer graphics object compositing block, an image generating block, and the user interface block. The present invention can provide diverse production methods such as testing for the optimal camera viewpoint and scenic structure before contents are actually authored and compositing two different scenes taken in different places into one scene based on a concept of a three-dimensional virtual studio in the respect of a contents producer.

### TECHNICAL FIELD

The present invention relates to an apparatus and method for generating multi-view contents; and, more particularly, to a multi-view contents generating apparatus that can support functions of moving object substitution, depth-based object insertion, background image substitution, and view offering upon a user request and provide more realistic image by applying lighting information applied to a real image to computer graphics object when a real image is composited with computer graphics object, and a method thereof.

### BACKGROUND ART

Generally, a contents generating system refers to a process from an image acquisition through a camera to transformation into a format for storage or transmission by processing the acquired image. In short, it deals with a process of editing images photographed with the camera by using diverse editing tools and authoring tools, adding special effects, and captioning.

A virtual studio, which is one of the contents generating system, composites picture of an actor photographed in front of a blue screen with prepared two or three-dimensional computer graphics background based on Chroma-key.

Thus, there is a restriction that the actor cannot stand in front of a camera in blue clothes. And, there is a limitation in producing depth-based scenes since simple substitution of colors is performed. Also, although the background is generated by the three-dimensional computer graphics, it is hard to produce a scene where a plurality of actors and a plurality of computer graphic models are overlapped because the combination is simply performed by inserting the three-dimensional background instead of the blue color.

Also, since conventional two-dimensional contents generating systems provide images of one view, they cannot provide stereoscopic images or virtual multi-view images that give viewers depth perception and they cannot provide images of diverse viewpoints desired by the viewers.

As described above, the virtual studio system conventionally used in broadcasting stations or the contents generating system such as image contents authoring tools has a problem that the depth perception is degraded by presenting images in two-dimensional although it uses a three-dimensional computer graphic model.

In short, since the systems related to contents generation and production which are used for current broadcasting are developed for the existing two-dimensional broadcasting, there is a limitation in generating contents that support future multi-view stereoscopic image services.

### DISCLOSURE

Technical Problem

It is, therefore, an object of the present invention, which is devised to resolve the aforementioned problems, to provide a multi-view contents generating apparatus that can provide the depth perception by generating binocular or multi-view 3D images; support interactions of moving object substitution, depth-based object insertion, background image substitution, and view offering upon a user request, and a method thereof.

The other objects and advantages of the present invention will be described by the following descriptions and they could be understood more clearly with reference to the following embodiments. Also, the objects and advantages of the present invention can be easily realized by the means as claimed and combinations thereof.

Technical Solution

In accordance with one aspect of the present invention, there is provided an apparatus for generating multi-view contents, which includes: a preprocessing block for performing correction on and removing noise from depth/disparity map data and a multi-view image which are inputted from outside to thereby produce corrected multi-view images; a camera calibration block for calculating camera parameters based on basic camera information and the corrected multi-view images corrected in the preprocessing block, and performing epipolar rectification to thereby produce an rectified multi-view image to thereby produce an rectified image; a scene model generating block for generating a scene model by using the camera parameters and the rectified multi-view image, which are outputted from the camera calibration block, and a depth/disparity map which is outputted from the preprocessing block; an object extracting/tracing block for extracting an object binary mask, an object motion vector, and a position of an object central point by using the corrected multi-view images outputted from the preprocessing block, the camera parameters outputted from the camera calibration block, and target object setting information outputted from the user interface block; a real image/computer graphics object compositing block for extracting lighting information of a background image, which is a real image, applying the extracted lighting information when a pre-produced computer graphics obejct is inserted into the real image, and compositing the pre-produced computer graphics object and the real image; an image generating block for generating stereoscopic images, multi-view images, and intermediate-view images by using the camera parameters outputted from the camera calibration block, the user selected viewpoint information outputted from a user interface block, and the multi-view image corresponding to the user selected viewpoint information; and the user interface block for converting requirements from a user into internal data and transmitting the internal data to the preprocessing block, the camera calibration block, the scene modeling block, the object extracting/tracing block, the real image/computer graphics object compositing block, and the image generating block.

In accordance with another aspect of the present invention, there is provided a method for generating multi-view contents, which includes the steps of: a) performing correction on and removing noise from depth/disparity map data and multi-view images which are inputted from outside to thereby produce corrected multi-view images; b) calculating camera parameters based on basic camera information and the corrected multi-view images and performing epipolar rectification to thereby produce rectified multi-view images; c) generating a scene model by using the camera parameters and the rectified multi-view images, which are outputted from the step b), and the preprocessed depth/disparity map which is outputted from the step a); d) extracting an object binary mask, an object motion vector, and a position of an object central point by using target object setting information, the corrected multi-view images, and the camera parameters; e) extracting lighting information of a background image, which is a real image, applying the lighting information extracted when a pre-produced computer graphics object is inserted into the real image, and compositing the pre-produced computer graphics object and the real image; and f) generating stereoscopic images, multi-view images, and intermediate-view images by using user selected viewpoint information, the virtual multi-view images corresponding to the user selected viewpoint information, and the camera parameters.

Advantageous Effects

The present invention described above can provide stereoscopic images of diverse viewpoints desired by user, and provide an interactive service such as adding a virtual object desired by the user and compositing virtual objects and the real background, and it can be used to produce contents for the broadcasting system supporting interactivity and stereoscopic image services in the respect of a transmission system.

Also, the present invention can provide diverse production methods such as testing for the optimal camera viewpoint and scenic structure before contents are actually authored and compositing two different scenes taken in different places into one scene based on a concept of a three-dimensional virtual studio in the respect of a contents producer.

### DESCRIPTION OF DRAWINGS

The above and other objects and features of the present invention will become apparent from the following description of the preferred embodiments given in conjunction with the accompanying drawings, in which:

FIG. 1 is a block diagram illustrating a multi-view contents generating system in accordance with an embodiment of the present invention;

FIG. 2 is a block diagram describing an image and depth/disparity map preprocessing block of FIG. 1 in detail;

FIG. 3 is a block diagram showing a camera calibration block of FIG. 1 in detail;

FIG. 4 is a block diagram showing a scene-modeling block of FIG. 1 in detail;

FIG. 5 is a block diagram depicting an object extracting and tracing block of FIG. 1 in detail;

FIG. 6 is a block diagram describing a real image/computer graphics object compositing block of FIG. 1 in detail;

FIG. 7 is a block diagram illustrating an image generating block of FIG. 1 in detail; and

FIG. 8 is a flowchart describing a multi-view contents generating method in accordance with an embodiment of the present invention.

### BEST MODE FOR THE INVENTION

Other objects and aspects of the invention will become apparent from the following description of the embodiments with reference to the accompanying drawings, which is set forth hereinafter.

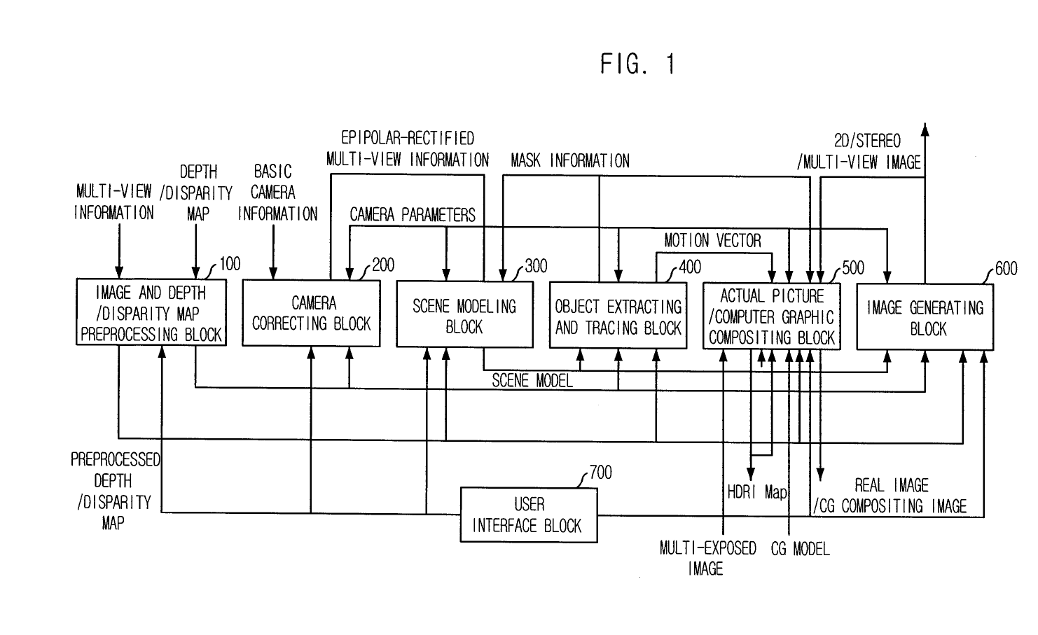

FIG. 1 is a block diagram illustrating a multi-view contents generating system in accordance with an embodiment of the present invention.

As illustrated, the multi-view contents generating system of the present invention includes an image and depth/disparity map preprocessing block 100, a camera calibration block 200, a scene modeling block 300, an object extracting and tracing block 400, a real image/computer graphics object compositing block 500, an image generating block 600, and a user interface block 700. The image and depth/disparity map preprocessing block 100 receives multi-view images from the external multi-view cameras having more than two viewpoints and, if the sizes and colors of the multi-view images are different, corrects the difference to make multi-view images have the same sizes and colors.

Also, the image and depth/disparity map preprocessing block 100 receives depth/disparity map data from an external depth acquiring device and performs filtering to remove noise from the depth/disparity map data.

Here, the data inputted to the image and depth/disparity map preprocessing block 100 can be multi-view images having more than two viewpoints or a form of multi-view images having more than two viewpoints and depth/disparity map having one viewpoint.

The camera calibration block 200 computes and stores internal and external parameters of a camera with respect to each viewpoint based on the multi-view images photographed from each viewpoint, a set of feature points, and basic camera information.

Also, the camera calibration block 200 performs image rectification for aligning an epipolar line with a scan line with respect to two pairs of stereo images based on the feature points set and the camera parameters. The image correction is a process where an image of another viewpoint is transformed or retro-transformed based on one image to estimate disparity more accurately.

Here, the feature points are extracted for camera calibration from the camera calibration pattern pictures or from images by using a feature point extracting method.

The scene modeling block 300 generates disparity maps based on the internal and external parameters outputted from the camera calibration block 200 and the epipolar-rectified multi-view images, and generates a scene model by integrating the generated disparity map with the preprocessed depth/disparity map.

Also, the scene modeling block 300 generates a mask having depth information of each moving object based on binary mask information of the moving object outputted from the object extracting and tracing block 400, which will be described later.

The object extracting and tracing block 400 extracts the binary mask information of the moving object and a motion vector at the unit of an image coordinates system and a world coordinates system by using the multi-view images and depth/disparity map, which is outputted from the image and depth/disparity map preprocessing block 100, camera information and positional relation, which are outputted from the camera calibration block 200, the scene model, which is outputted from the scene modeling block 300, and user input information. Here, the moving object can be more than two and each object has its own identifier.

The real image/computer graphics object compositing block 500 composites a pre-authored computer graphics object and a real image, inserts computer graphics objects at the three-dimensional position/trace of an object outputted from the object extracting and tracing block 400, and substitutes the background with another real image or a computer graphic background.

Also, the real image/computer graphics object compositing block 500 extracts lighting information on a background image, which is a real image, into which the computer graphics object is to be inserted, and performs rendering by applying the extracted lighting information when the computer graphics object is virtually inserted into the real image.

The image generating block 600 generates two-dimensional images, stereoscopic images, and virtual multi-view images by using the preprocessed multi-view images, the depth/disparity map free from noise, the scene model, and the camera parameters. Here, when the user selects a three-dimensional (3D) mode, the image generating block 600 generates stereoscopic images or virtual multi-view images according to a selected viewpoint. Moreover, the image generating block generates 2D/stereoscopic/multi-view images and displays according to the selected 2D or 3D mode (stereoscopic/multi-view). Also, it generates stereoscopic images or virtual multi-view images from the Depth Image Based Rendering (DIBR) technique by using a one-view image and a depth/disparity map corresponding thereto. The user interface block 700 provides an interface that transforms diverse user requests such as viewpoint alteration, object selection/substitution, background substitution, 2D/3D display mode switching, and file and screen input/output, into internal data structure, transmits them to corresponding processing units, operates system menu, and performs the entire control function. Here, the user can check the state of a current process through Graphic User Interface (GUI).

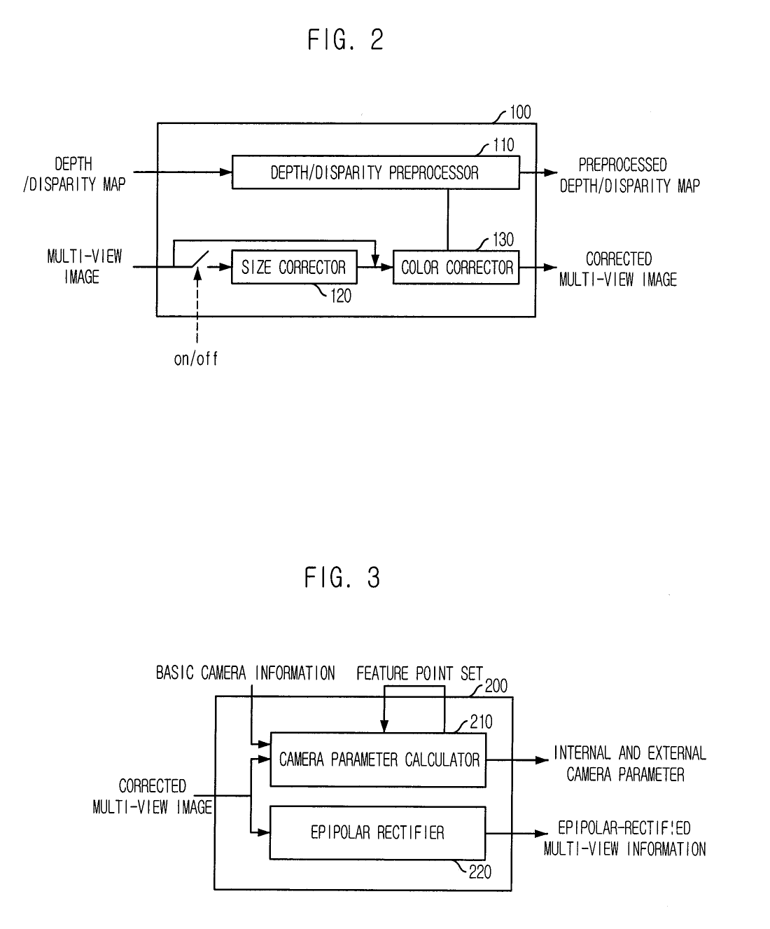

FIG. 2 is a block diagram describing an image and depth/disparity map preprocessing block of FIG. 1 in detail.

As shown, the image and depth/disparity map preprocessing block 100 includes a depth/disparity preprocessor 110, a size corrector 120, and a color corrector 130.

The depth/disparity preprocessor 110 receives depth/disparity map data from an external depth acquiring device and performs filtering for removing noise from the depth/disparity map data to thereby output noise-free depth/disparity map data.

The size corrector 120 receives multi-view images from the external multi-view camera having more than two viewpoints and, when the sizes of the multi-view images are different, corrects the sizes of the multi-view images and outputs multi-view images of the same size. Also, when a plurality of images are inputted in one frame, the inputted image is separated into multiple images with the same size.

The color corrector 130 corrects and outputs the colors of the multi-view images to be the same, when the colors of the multi-view images inputted from the external multi-view camera are not the same due to color temperature, white balance and black balance. Here, the reference image for the color correction can be different according to the characteristics of an input image.

FIG. 3 is a block diagram showing a camera calibration block of FIG. 1 in detail.

As shown in FIG. 3, the camera calibration block 200 includes a camera parameter calculator 210 and an epipolar rectifier 220.

The camera parameter calculator 210 calculates and outputs internal and external camera parameters based on the basic camera information such as CCD size and the multi-view images outputted from the image and depth/disparity map preprocessing block 100, and stores the calculated parameters. Here, the camera parameter calculator 210 can support the automatic/semiautomatic function of extracting feature points out of the input image to calculate the internal and external camera parameters and also receives a set of feature points from the user interface block 700.

The epipolar rectifier 220 performs epipolar rectification between an image of a reference viewpoint and images of the other viewpoints based on the internal/external camera parameters outputted from the camera parameter calculator 210 and outputs rectified multi-view images.

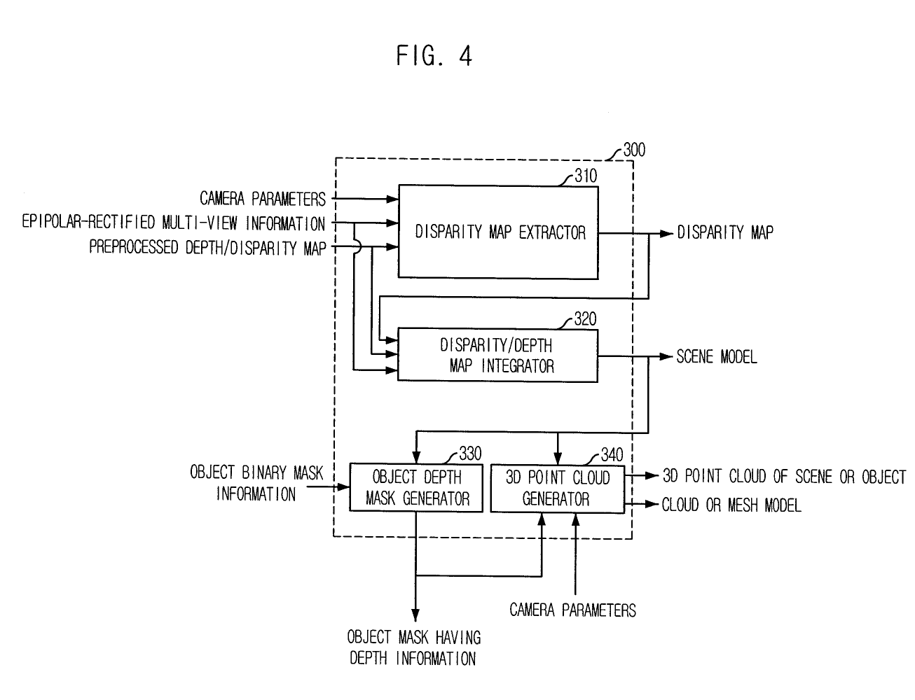

FIG. 4 is a block diagram showing a scene modeling block of FIG. 1 in detail. As shown, the scene modeling block 300 includes a disparity map extractor 310, a disparity/depth map integrator 320, an object depth mask generator 330, and a three-dimensional point cloud generator 340.

The disparity map extractor 310 generates and outputs a plurality of disparity maps by using the internal and external camera parameters and the rectified multi-view images that are outputted from the camera calibration block 200. Here, when the disparity map extractor 310 additionally receives a preprocessed depth/disparity map transmitted from the depth/disparity preprocessor 110, it determines an initial condition for acquiring an improved disparity/depth map and a disparity search area based on the preprocessed depth/disparity map.

The disparity/depth map integrator 320 generates and outputs an improved disparity/depth map, i.e., a scene model, by integrating the disparity maps outputted from the disparity map extractor 310, the preprocessed depth/disparity map outputted from the depth/disparity preprocessor 110 and the rectified multi-view images outputted from the epipolar rectifier 220.

The object depth mask generator 330 generates and outputs an object mask having depth information of each moving object by using the moving object binary mask information outputted from the object extracting and tracing block 400 and the scene model outputted from the disparity/depth map integrator 320.

The three-dimensional point cloud generator 340 generates and outputs a mesh model and a three-dimensional point cloud of a scene or an object by converting the object mask having depth information, which is outputted from the object depth mask generator 330, or the scene model, which is outputted from the disparity/depth map integrator 320, based on the internal and external camera parameters outputted from the camera parameter calculator 210.

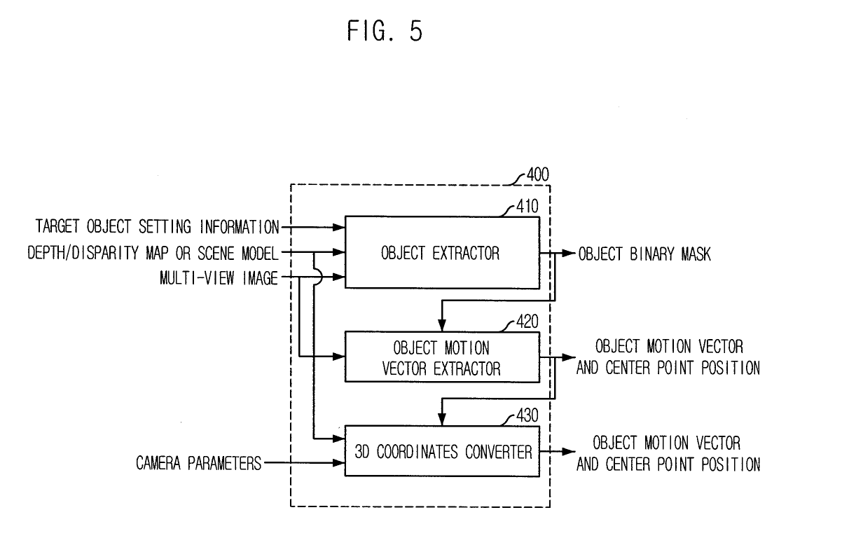

FIG. 5 is a block diagram depicting an object extracting and tracing block of FIG. 1 in detail. As illustrated in FIG. 5, the object extracting and tracing block 400 includes an object extractor 410, an object motion vector extractor 420, and a three-dimensional coordinates converter 430.

The object extractor 410 extracts a binary mask for each view, which is a silhouette, by using the multi-view images outputted from the image and depth/disparity map preprocessing block 100 and target object setting information outputted from the user interface block 700, and if there are a plurality of objects, an identifier is given to each object to identify them.

Here, if the preprocessed depth/disparity map from the depth/disparity preprocessor 110 or the scene model from the disparity/depth map integrator 320 is inputted additionally, the object extractor 410 extracts an object binary mask by using the depth information and the color information simultaneously.

The object motion vector extractor 420 extracts a central point of the object binary mask outputted from the object extractor 410, and calculates and stores image coordinates of the central point for every frame. Here, when there are a plurality of objects which are traced, each object is traced with its own identifier. When an object is covered by another object, a target object is traced by additionally using images of different viewpoints other than the reference viewpoint, and a temporal change, which is a motion vector, is calculated for each frame.

The three-dimensional coordinates converter 430 converts the image coordinates of the object motion vector outputted from the object motion vector extractor 420 into three-dimensional world coordinates by using the depth/disparity map outputted from the image and depth/disparity map preprocessing block 100, the scene model outputted from the scene modeling block 300, and the internal and external camera parameters outputted from the camera calibration block 200.

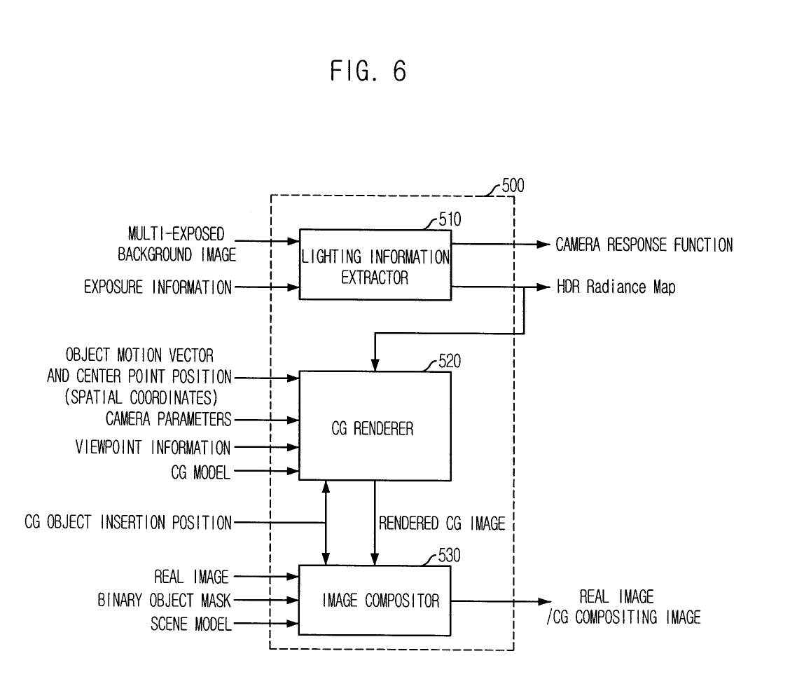

FIG. 6 is a block diagram describing a real image/computer graphics object compositing block of FIG. 1 in detail. As illustrated in FIG. 6, the real image/computer graphics object compositing block 500 includes a lighting information extractor 510, a computer graphic renderer 520, and an image compositor 530.

The lighting information extractor 510 calculates an HDR Radiance map and a camera response function based on multiple exposure background images outputted from the user interface block 700 and exposure information thereof to extract lighting information applied to the real image. The HDR radiance map and the camera response function are used to enhance the realism when a computer graphics object is inserted into the real image.

The computer graphics object renderer 520 renders a computer graphics object model by using the viewpoint information, the computer graphics (CG) object model, and computer graphics object insertion position, which are transferred from the user interface block 700, the internal and external camera parameters, which are transferred from the camera calibration block 200, the object motion vector and the position of the central point transferred from the object extracting and tracing block 400.

Here, the computer graphic renderer 520 controls the size and viewpoint to match those of the computer graphics object model with those of the real image. Also, the lighting effect is applied to the computer graphics object by using the HDR radiance map having actual lighting information outputted from the lighting information extractor 510 and the Bidirectional Reflectance Distribution Function (BRDF) coefficients of the computer graphics object model.

The image compositor 530 inserts the computer graphics object model in the position of the real image which is desired by the user based on a depth key and generates a real image/computer graphics object compositing image by using the real image of the current viewpoint, the scene model transferred from the scene modeling block 300, the binary object mask outputted from the object extracting and tracing block 400, the object insertion position outputted from the user interface block 700, and the rendered computer graphic image outputted from the computer graphic renderer 520.

Also, the image compositor 530 substitutes an actual moving object with the computer graphics object model based on the object motion vector and the object binary mask outputted from the object extracting and tracing block 400, or substitutes the actual background with another computer graphics background by using the object binary mask.

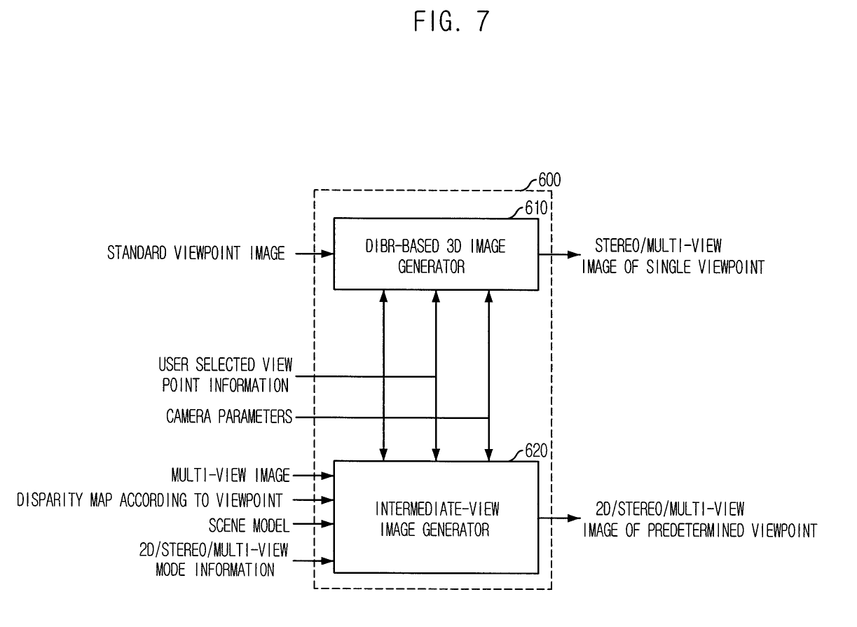

FIG. 7 is a block diagram illustrating an image generating block of FIG. 1 in detail. As shown in FIG. 7, the image generating block 600 includes a DIBR-based stereoscopic image generator 610 and an intermediate-view image generator 620.

The DIBR-based stereoscopic image generator 610 generates a stereoscopic image and virtual multi-view images by using the internal and external camera parameters outputted from the camera calibration block 200, the user selected viewpoint information outputted from the user interface block 700, and a reference view image corresponding to the user selected viewpoint information. Also, a hole or a covered region is processed as well.

Here, the reference view image means an image of one viewpoint selected by the user among multi-view images outputted from the image and depth/disparity map preprocessing block 100, a depth/disparity map outputted from the image and depth/disparity map preprocessing block 100 corresponding to an image of one viewpoint, or a disparity map outputted from the scene modeling block 300.

The intermediate-view image generator 620 generates intermediate-view images by using the multi-view images and depth/disparity map, which are outputted from the image and depth/disparity map preprocessing block 100, the scene model or a plurality of disparity maps, which is/are outputted from the scene modeling block 300, the camera parameters outputted from the camera calibration block 200, and the user selected viewpoint information outputted from the user interface block 700. Here, the intermediate-view image generator 620 outputs images in the selected form according to the 2D/stereo/multi-view mode information outputted from the user interface block 700. Meanwhile, when a hole, i.e., a hidden texture, is generated in the generated image, the hidden texture is corrected by using color image textures of other viewpoints.

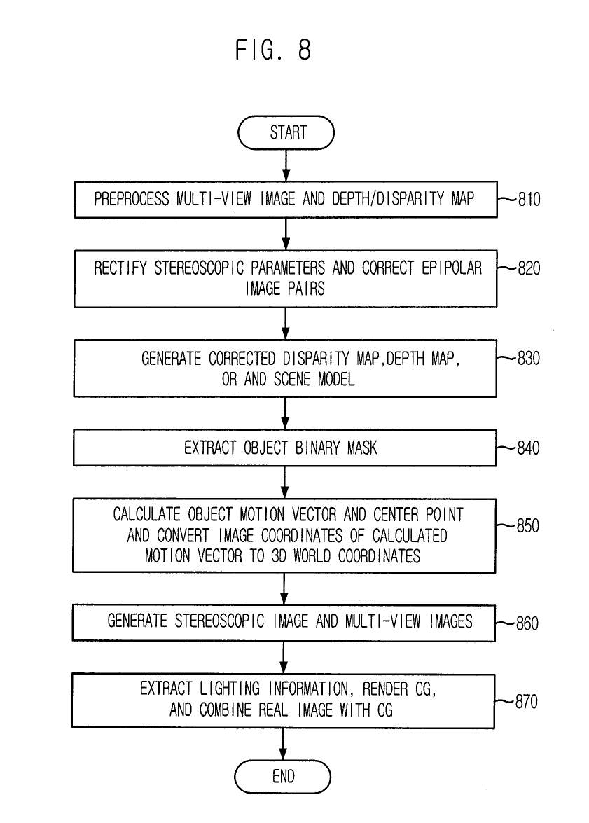

FIG. 8 is a flowchart describing a multi-view contents generating method in accordance with an embodiment of the present invention. As described in FIG. 8, in step 810, depth/disparity map data and multi-view images inputted from the outside are preprocessed. In other words, the sizes and colors of the inputted multi-view images are corrected, and filtering is carried out to remove noise from the inputted depth/disparity map data.

In step 820, internal and external camera parameters are calculated based on basic camera information, the corrected multi-view images, and a set of feature points, and epipolar rectification is performed based on the calculated camera parameters.

Subsequently, in step 830, a plurality of disparity maps are generated by using the camera parameters and the rectified multi-view images, and a scene model is generated by integrating the generated disparity maps and the preprocessed depth/disparity maps. Here, the preprocessed depth/disparity map can be used additionally for the generation of the improved disparity/depth map. Also, an object mask having depth information is generated by using object binary mask information extracted from a step 840, which will be described later, and the scene model, and a three-dimensional point cloud of a scene/object and a mesh model can be generated based on the calculated camera parameters.

In step S840, a binary mask of an object is extracted based on target object setting information of a user and at least one among corrected multi-view images, preprocessed depth/disparity map, and a scene model.

Subsequently, in step S850, an object motion vector and a position of a central point are calculated based on the extracted binary mask, and image coordinates of the motion vector are converted into three-dimensional world coordinates.

In step S860, stereoscopic images at the viewpoint selected by the user and an intermediate viewpoint and virtual multi-view images are generated based on the calculated camera parameters and at least one among the preprocessed multi-view images, the depth/disparity maps, and the scene model.

Finally, in step S870, lighting information for the background image is extracted, and a pre-produced computer graphics object model is rendered based on the lighting information and the viewpoint information from the user, and then the rendered computer graphic image is composited with the real image based on a depth key according to a computer graphics object insertion position selected by the user. Here, the lighting information for the background image, which is the real image, is extracted based on a plurality of images with different light exposure and exposure values thereof.

Meanwhile, when a real image is composited with a computer graphics image, a real image is generated first and then it is rendered with the computer graphics image, typically. However, it is possible to render the computer graphics image first and then generate the real image for determining a viewpoint due to the computational complexity. Therefore, the processes of the steps 860 and 870 may be interchanged.

The method of the present invention can be realized as a program and recorded in a computer-readable recording medium, such as CD-ROM, RAM, ROM, floppy disks, hard disks, magneto-optical disks and the like. Since the processes can be easily implemented by those skilled in the art of the present invention, further description on it will not be provided herein.

While the present invention has been described with respect to certain preferred embodiments, it will be apparent to those skilled in the art that various changes and modifications may be made without departing from the scope of the invention as defined in the following claims.

What is claimed is:

1. An apparatus for generating multi-view contents, comprising:
a preprocessing block for performing correction on and removing noise from depth/disparity map data and multi-view images which are inputted from outside to thereby produce corrected multi-view images;
a camera calibration block for calculating camera parameters based on basic camera information and the corrected multi-view images outputted from the preprocessing block, and performing epipolar rectification to thereby produce rectified multi-view images;
a scene model generating block for generating a scene model by using the camera parameters and the epipolar-rectified multi-view images, which are outputted from the camera calibration block, and a depth/disparity map which is outputted from the preprocessing block;
an object extracting/tracing block for extracting an object binary mask, an object motion vector, and a position of an object central point by using the rectified multi-view images outputted from the preprocessing block, the camera parameters outputted from the camera calibration block, and target object setting information outputted from the user interface block;
a real image/computer graphics object compositing block for extracting lighting information of a background image, which is a real image, applying the extracted lighting information when a pre-produced computer graphic is inserted into the real image, and compositing the pre-produced computer graphics model and the real image;
an image generating block for generating stereoscopic images, virtual multi-view images, and intermediate-view images by using the camera parameters outputted from the camera calibration block, the user selected viewpoint information outputted from a user interface block, and the virtual multi-view images corresponding to the user selected viewpoint information; and
the user interface block for converting requirements from a user into internal data and transmitting the internal data to the preprocessing block, the camera calibration block, the scene modeling block, the object extracting/tracing block, the real image/computer graphics object compositing block, and the image generating block.

2. The apparatus as recited in claim 1, wherein the preprocessing block includes:
a size corrector for correcting the multi-view images to have the same size, when the sizes of the multi-view images are different;
a color corrector for correcting the multi-view images to have the same colors based on a color correction algorithm, when the colors of the multi-view images are different; and
a depth/disparity preprocessor for removing noise from the depth/disparity data through filtering.

3. The apparatus as recited in claim 1, wherein the camera calibration block includes:
a parameter calculator for extracting the camera parameters based on the basic camera information and the corrected multi-view images outputted from the preprocessing block; and
an epipolar rectifier for performing epipolar rectification of the multi-view images outputted from the preprocessing block based on the camera parameters outputted from the parameter calculator.

4. The apparatus as recited in claim 1, wherein the scene model generating block includes:
a disparity map extractor for generating a plurality of disparity maps by using the camera parameters outputted from the camera calibration block and the epipolar-rectified multi-view images;
an integrator for generating a scene model by integrating a disparity map outputted from the disparity map extractor and a depth/disparity map outputted from the preprocessing block;
an object depth mask generator for generating an object mask having depth information by using the object binary mask information outputted from the object extracting/tracing block and the scene model outputted from the integrator; and
a three-dimensional point cloud generator for generating a three-dimensional point cloud of a scene/object and a mesh model by using the camera parameters outputted from the camera calibration block.

5. The apparatus as recited in claim 1, wherein the object extracting/tracing means includes:
an object extractor for extracting an object binary mask by using at least one among the multi-view images outputted from the preprocessing block, the preprocessed depth/disparity map outputted from the preprocessing block, and the scene model outputted from the scene model generating block, and the target object setting information outputted from the user interface block;
an object motion vector extractor for extracting a central point of the object binary mask outputted from the object extractor, and calculating and storing image coordinates of the central point for every frame; and
a three-dimensional coordinates converter for converting image coordinates of the object motion vector outputted from the object motion vector extractor into three-dimensional world coordinates by using at least one between the depth/disparity map outputted from the preprocessing block and a scene model outputted from the scene model generator, and the camera parameters outputted from the camera calibration block.

6. The apparatus as recited in claim 1, wherein the real image/computer graphics object compositing block includes:
a lighting information extractor for extracting lighting information of the background image, which is the real image, based on a plurality of images with different light exposure levels and light exposure values thereof;
a computer graphic renderer for rendering computer graphics object according to a viewpoint based on viewpoint information outputted from the user interface block; and
an image compositor for inserting a computer graphics object model into the real image based on a depth key according to a computer graphic insertion position transmitted from the user interface block.

7. The apparatus as recited in claim 1, wherein the image generating block includes:
a stereoscopic image generator for generating stereoscopic images, virtual multi-view images by using the multi-view images outputted from the preprocessing block, at least one between the preprocessed depth/disparity map and the scene model outputted from the scene model generating block, and the camera parameters from the camera calibration block; and
an intermediate-view image generator for generating intermediate-view images by using the multi-view images outputted from the preprocessing block, at least one among the preprocessed depth/disparity map outputted from the preprocessing block, the scene model outputted from the scene model generating block, and a plurality of disparity maps outputted from the scene model generating block, the user selected viewpoint information outputted from the user interface block.

8. A method for generating multi-view contents, comprising the steps of:
a) performing correction on and removing noise from depth/disparity map data and multi-view images which are inputted from outside to thereby produce a corrected multi-view images;
b) calculating camera parameters based on basic camera information and the corrected multi-view images and performing epipolar rectification to thereby produce epipolar-rectified multi-view images;
c) generating a scene model by using the camera parameters and the epipolar-rectified multi-view images, which are outputted from the step b), and the preprocessed depth/disparity maps which are outputted from the step a);
d) extracting an object binary mask, an object motion vector, and a position of an object central point by using target object setting information, the corrected multi-view images, and the camera parameters;
e) extracting lighting information of a background image, which is a real image, applying the lighting information extracted when a pre-produced computer graphic is inserted into the real image, and compositing the pre-produced computer graphic and the real image; and
f) generating stereoscopic images, virtual multi-view images, and intermediate-view images by using user selected viewpoint information, the multi-view images corresponding to the user selected viewpoint information, and the camera parameters.

9. The method as recited in claim 8, wherein the step a) includes the steps of:
a1) correcting the multi-view images to have the same size, when the sizes of the multi-view images are different;
a2) correcting the multi-view images to have the same colors based on a color correction algorithm, when the colors of the multi-view images are different; and
a3) removing noise from the depth/disparity data through filtering.

10. The method as recited in claim 8, wherein the step b) includes the steps of:
b1) extracting the camera parameters based on the basic camera information and the corrected multi-view images; and
b2) performing epipolar rectification on the multi-view images based on the camera parameters to thereby produce epipolar-rectified multi-view images.

11. The method as recited in claim 8, wherein the step c) includes the steps of:
c1) generating a plurality of disparity maps by using the camera parameters and the epipolar-rectified multi-view images;
c2) generating a scene model by integrating a disparity map outputted from the step c1) and the preprocessed depth/disparity map outputted from the step a);
c3) generating an object mask having depth information by using the object binary mask information outputted from the step d) and the scene model generated in the step c2); and
c4) generating a three-dimensional point cloud of a scene/object and a mesh model by using the camera parameters outputted from the step b).

12. The method as recited in claim 8, wherein the step d) includes the steps of:
d1) extracting an object binary mask by using at least one among the corrected multi-view images outputted from the step a), the preprocessed depth/disparity map, and the scene model generated in the step c), and target object setting information inputted from a user;
d2) extracting a central point of the object binary mask extracted in the step d1), and calculating and storing image coordinates of the central point for every frame; and
d3) converting image coordinates of the object motion vector outputted from the step d2) into three-dimensional world coordinates by using at least one between the depth/disparity map preprocessed in the step a) and the scene model generated in the step c), and the camera parameters calculated in the step b).

13. The method as recited in claim 8, wherein the step e) includes the steps of:
e1) extracting lighting information of the background image, which is the real image, based on a plurality of images with different light exposure levels and light exposure values thereof;
e2) rendering computer graphics object according to a viewpoint based on viewpoint information transmitted from the user; and
e3) inserting a computer graphics object model into the real image based on a depth key according to a computer graphic insertion position transmitted from the user interface block.

14. The method as recited in claim 8, wherein the step f) includes the steps of:
f1) generating stereoscopic images and virtual multi-view images by using at least among the multi-view images preprocessed in the step a), the preprocessed depth/disparity map and the scene model generated in the step c), the camera parameters calculated in the step b), and user selected viewpoint information; and
f2) generating intermediate-view images by using at least one among the multi-view images preprocessed in the step a), the preprocessed depth/disparity map, the scene models generated in the step c), a plurality of disparity maps generated in the step c), the camera parameters, and the user selected viewpoint information.
